(19) United States
(12) Patent Application Publication
(10) Pub. No.: US 2024/0426869 A1
(43) Pub. Date: Dec. 26, 2024

(54) METHOD AND APPARATUS FOR SCANNING A SAMPLE WITH A PROBE

(71) Applicant: INFINITESIMA LIMITED, Abingdon Oxfordshire (GB)

(72) Inventors: Andrew David Laver Humphris, Abingdon Oxfordshire (GB); John Patrick Hole, Abingdon Oxfordshire (GB); Matthew Tedaldi, Abingdon Oxfordshire (GB); Jamie Kayne Hobbs, Yorkshire (GB); Xinyue Chen, Yorkshire (GB)

(21) Appl. No.: 18/698,671

(22) PCT Filed: Oct. 7, 2022
(86) PCT No.: PCT/GB2022/052546

§ 371 Date: Apr. 4, 2024

(30) Foreign Application Priority Data
Oct. 7, 2021 (GB) 2114391.2
Jan. 20, 2022 (GB) 2200684.5

(51) Int. Cl. G01Q 10/06; G01Q 20/00; G01Q 30/04; G01Q 40/00

(52) U.S. Cl. CPC G01Q 10/06; G01Q 20/00; G01Q 30/04; G01Q 40/00

(57) ABSTRACT

A method of measuring a sample with a probe including a cantilever mount, a cantilever extending from the cantilever mount to a free end, and a probe tip carried by the free end of the cantilever is disclosed. The method includes taking a series of measurements of a sidewall of the sample with the probe; and analysing the series of measurements to determine a characteristic of the sidewall. The measurements are taken during a measurement cycle that includes a pair of measurement drive phases. The measurement drive phases include first and second drive phases in which the probe is driven, respectively, down, then up, next to the sidewall. During one of the drive phases the probe tip interacts with the sidewall, and the series of measurements are taken by measuring an angle of the cantilever as the probe tip interacts with the sidewall during the one of the drive phases.

### FIELD OF THE INVENTION

The present invention relates to a method and apparatus for scanning a sample with a probe, in particular for scanning a sidewall of the sample.

### BACKGROUND OF THE INVENTION

Scanning probe systems for scanning samples and obtaining information about sample surfaces are known. Typically the scanning probe system comprises a probe that approaches the sample surface and obtains a measurement point upon contacting the sample surface in order to obtain information about the sample. However, scanning probe systems are not well suited to scanning a sidewall of a sample.

### SUMMARY OF THE INVENTION

A first aspect of the invention provides a method of measuring a sample with a probe, the probe comprising a cantilever mount, a cantilever extending from the cantilever mount to a free end, and a probe tip carried by the free end of the cantilever, the method comprising: taking a series of sidewall measurements of a sidewall of the sample with the probe; and analysing the series of sidewall measurements to determine a characteristic of the sidewall, wherein: the sidewall measurements are taken during a sidewall measurement cycle, the sidewall measurement cycle comprises a pair of sidewall measurement drive phases, the pair of sidewall measurement drive phases comprises a first drive phase in which the probe is driven down next to the sidewall followed by a second drive phase in which the probe is driven up next to the sidewall, during one of the sidewall measurement drive phases the probe tip interacts with the sidewall, and the series of sidewall measurements are taken by measuring an angle of the cantilever as the probe tip interacts with the sidewall during the one of the sidewall measurement drive phases.

Typically the cantilever changes shape (for instance by flexing and/or twisting) as the probe tip interacts with the sidewall, and the sidewall measurements are indicative of the changing shape of the cantilever.

Typically the cantilever mount is driven down and up during the first and second drive phases to cause the motion of the probe. Alternatively, the motion of the probe during the first and second drive phases may be caused by bending and unbending of the cantilever.

In the first drive phase the probe is next to the sidewall, optionally with the probe tip within 100 nm of the sidewall, within 50 nm of the sidewall, within 10 nm of the sidewall, or within 5 nm of the sidewall.

In the second drive phase the probe is next to the sidewall, optionally with the probe tip within 100 nm of the sidewall, within 50 nm of the sidewall, within 10 nm of the sidewall, or within 5 nm of the sidewall.

The series of sidewall measurements may be taken by measuring an angle of the cantilever as the probe interacts with the sidewall during the second drive phase, and/or by measuring an angle of the cantilever as the probe interacts with the sidewall during the first drive phase.

The probe may not interact with the sidewall during the first drive phase. More specifically, the probe may only interact with the sidewall during the second drive phase.

The probe may not interact with a base of the sidewall during the sidewall measurement drive phases. In other words the probe may not interact with a lower portion of the sidewall that contacts a lower surface that adjoins the sidewall. Alternatively or additionally the probe may not interact with the lower surface during a sidewall measurement cycle.

During the sidewall measurement cycle the sidewall may apply a force to the probe tip which causes the cantilever to twist. The force applied by the sidewall may be an attractive force, such as a Van der Waals force or an attractive electrostatic force caused by application of an electric charge to one or both of the sample and probe. Alternatively the force may be a repulsive force, such as a Pauli exclusion force or a repulsive electrostatic force caused by application of an electric charge to one or both of the sample and probe.

The probe tip interacting with the sidewall may comprise the probe tip contacting the sidewall.

The probe tip interacting with the sidewall may comprise a sliding interaction.

Optionally the probe tip has an asperity which extends laterally from the probe tip and contacts the sidewall as the probe tip interacts with the sidewall.

The characteristic of the sidewall may be a geometric characteristic of the sidewall. The geometric characteristic may be a profile of the sidewall or information regarding geometric features of the sidewall, such as protrusions and/or recesses.

The characteristic of the sidewall may alternatively or additionally be a material characteristic.

Analysing the series of sidewall measurements to determine a characteristic of the sidewall may comprise calculating a work done.

The series of sidewall measurements may comprise at least one of flexural measurements of the cantilever, and torsional measurements of the cantilever.

Optionally the series of sidewall measurements are taken by a quadrant photodiode.

Optionally a series of height measurements are taken by measuring a height of the cantilever as the probe tip interacts with the sidewall during the one of the sidewall measurement drive phases. The series of height measurements may be indicative of a height of a base of the cantilever at the cantilever mount, or the series of height measurements may be indicative of a height of the free end of the cantilever. Optionally the series of height measurements are taken by an interferometer. The height measurements may be used along with the sidewall measurements to determine the characteristic of the sidewall.

During the sidewall measurement drive phases, the cantilever mount may be driven in a substantially straight line.

The method may further comprise applying a dither signal to the probe during the first drive phase to cause a dither oscillation of the probe, and monitoring the dither oscillation to detect contact of the probe with the sample. The first drive phase may be terminated in response to the detection of the contact of the probe with the sample. Optionally the dither signal is not applied to the probe during the second drive phase. This lack of dither signal in the second drive phase makes it more easy to accurately measure the angle of the cantilever.

The method may further comprise performing two or more sidewall measurement cycles, and using the two or more sidewall measurement cycles to determine the characteristic of the sidewall. The probe may be at different distances from the sidewall during the sidewall measurement cycles.

Using the two or more sidewall measurement cycles to determine the characteristic of the sidewall may comprise one of: selecting one of the sidewall measurement cycles to determine the characteristic (for instance the cycle with the probe closest to the sidewall); or calculating an average of the sidewall measurement cycles to determine the characteristic.

The sample may comprise an upper surface which meets the sidewall at a convex corner, and a lower surface which meets the sidewall at a concave corner. Optionally the probe tip is in contact with the lower surface at the end of the first drive phase.

The series of sidewall measurements, taken during a single sidewall measurement cycle, may comprise more than 10 sidewall measurements, more than 100 sidewall measurements or more than 1000 sidewall measurements.

The method may further comprise: taking a series of upper surface measurements of the upper surface with the probe, wherein each upper surface measurement is taken during an upper surface measurement cycle, the upper surface measurement cycle comprising an approach drive phase in which the probe is driven down to the upper surface followed by a retract drive phase in which the probe is driven up and away from the upper surface; and taking a series of lower surface measurements of the lower surface with the probe, wherein each lower surface measurement is taken during a lower surface measurement cycle, the lower surface measurement cycle comprising an approach drive phase in which the probe is driven down to the lower surface followed by a retract drive phase in which the probe is driven up and away from the lower surface.

Optionally analysing the series of sidewall measurements to determine the characteristic of the sidewall comprises: inputting the series of sidewall measurements into a model, such has a trained machine, wherein the model determines the characteristic of the sidewall on the basis of the series of sidewall measurements.

A second aspect of the invention provides apparatus for measuring a sample with a probe, the apparatus comprising: a cantilever mount; a probe comprising a cantilever extending from the cantilever mount to a free end, and a probe tip carried by the free end of the cantilever; a driver configured to drive the probe; and a measurement system configured to measure an angle of the cantilever to generate a series of sidewall measurements; wherein the apparatus is configured to: take a series of sidewall measurements of a sidewall of the sample with the probe; and analyse the series of sidewall measurements to determine a characteristic of the sidewall, wherein: the sidewall measurements are taken during a sidewall measurement cycle, the sidewall measurement cycle comprises a pair of sidewall measurement drive phases, the pair of sidewall measurement drive phases comprise a first drive phase in which the probe is driven down next to the sidewall followed by a second drive phase in which the probe is driven up next to the sidewall, during one of the sidewall measurement drive phases the probe tip interacts with the sidewall, and the series of sidewall measurements are taken by measuring an angle of the cantilever as the probe tip interacts with the sidewall during the one of the sidewall measurement drive phases.

The driver may be a linear actuator and during the sidewall measurement drive phases, the cantilever mount may be moved by the driver.

The series of sidewall measurements may comprise at least one of flexural measurements of the cantilever, and torsional measurements of the cantilever, the measurement system optionally comprising a quadrant photodiode configured to measure at least one of the flexural measurements and the torsional measurements.

The measurement system may comprise an interferometer configured to measure a height of the cantilever.

Optionally the apparatus further comprises a model, such as a trained model, configured to determine the characteristic of the sidewall on the basis of the series of sidewall measurements.

Optionally the probe tip has an asperity which extends laterally from the probe tip.

A further aspect of the invention provides a method of measuring a test sidewall, the method comprising: obtaining a sidewall signature by measuring an interaction of a probe with a test sidewall, wherein the sidewall signature comprises a series of measurements which are taken at different points as the probe moves up or down the test sidewall; and inputting the sidewall signature into a model, such as a trained model, wherein the model determines a characteristic of the test sidewall on the basis of the sidewall signature.

Optionally the sidewall signature is obtained during a sidewall measurement cycle, the sidewall measurement cycle comprises a pair of sidewall measurement drive phases, the pair of sidewall measurement drive phases comprises a first drive phase in which the probe is driven down next to the test sidewall followed by a second drive phase in which the probe is driven up next to the test sidewall, during one of the sidewall measurement drive phases a probe tip of the probe interacts with the test sidewall, and the series of measurements are taken by measuring an angle of a cantilever of the probe as the probe tip interacts with the test sidewall during the one of the sidewall measurement drive phases.

A further aspect of the invention provides a method of generating a model, the method comprising: providing a plurality of calibration sidewalls, each having a different known characteristic; for each calibration sidewall, obtaining a calibration sidewall signature by measuring an interaction of a probe with the calibration sidewall, wherein the calibration sidewall signature comprises a series of measurements which are taken at different points as the probe moves up or down the calibration sidewall; and generating the model on the basis of the calibration sidewall signatures and the known characteristics of the calibration sidewalls.

Optionally each calibration sidewall signature is obtained during a sidewall measurement cycle, the sidewall measurement cycle comprises a pair of sidewall measurement drive phases, the pair of sidewall measurement drive phases comprises a first drive phase in which the probe is driven down next to the calibration sidewall followed by a second drive phase in which the probe is driven up next to the calibration sidewall, during one of the sidewall measurement drive phases a probe tip of the probe interacts with the calibration sidewall, and the series of measurements are taken by measuring an angle of a cantilever of the probe as the probe tip interacts with the calibration sidewall during the one of the sidewall measurement drive phases.

A further aspect of the invention provides apparatus for measuring a sidewall, the apparatus comprising: a probe; a measurement system configured to obtain a sidewall signature by measuring an interaction of the probe with a sidewall, wherein the sidewall signature comprises a series of measurements which are taken at different points as the probe moves up or down the sidewall; and a model, such as a trained model, configured to determine a characteristic of the sidewall on the basis of the sidewall signature.

Optionally the measurement system is configured to obtain the sidewall signature during a sidewall measurement cycle, the sidewall measurement cycle comprising a pair of sidewall measurement drive phases, the pair of sidewall measurement drive phases comprising a first drive phase in which the probe is driven down next to the sidewall followed by a second drive phase in which the probe is driven up next to the sidewall, during one of the sidewall measurement drive phases a probe tip of the probe interacts with the sidewall, and the series of measurements are taken by measuring an angle of a cantilever of the probe as the probe tip interacts with the sidewall during the one of the sidewall measurement drive phases.

### BRIEF DESCRIPTION OF THE DRAWINGS

Embodiments of the invention will now be described with reference to the accompanying drawings, in which:

FIG. 1 is a schematic representation of a scanning probe system in line with an embodiment of the invention;

FIG. 2 is a schematic representation of measurement apparatus incorporated into the system of FIG. 1;

FIG. 3 is a representation of a method in line with an embodiment of the invention;

FIG. 4 schematically illustrates a series of measurement cycles;

FIG. 5 schematically illustrates a trajectory of the probe tip during two sidewall measurement cycles at different distances next to a sidewall;

FIG. 6 is a representation of a sample and data collected from the sample using a method in line with an embodiment of the invention;

FIG. 7 is a representation of a further sample and data collected from the further sample using a method in line with an embodiment of the invention;

FIG. 8A shows a training/calibration sample with small recesses in its sidewalls;

FIG. 8B shows a training/calibration sample with medium recesses in its sidewalls;

FIG. 8C shows a training/calibration sample with large recesses in its sidewalls;

FIG. 9 shows a model generated from the samples of FIGS. 8A-C;

FIG. 10 shows an alternative model-based method;

FIG. 11 shows a method of training a neural network;

FIG. 12 shows a method of operating the neural network to analyse a test sample; and

FIG. 13 shows a method of measuring a sample with a probe, according to a further embodiment of the invention.

### DETAILED DESCRIPTION OF EMBODIMENT(S)

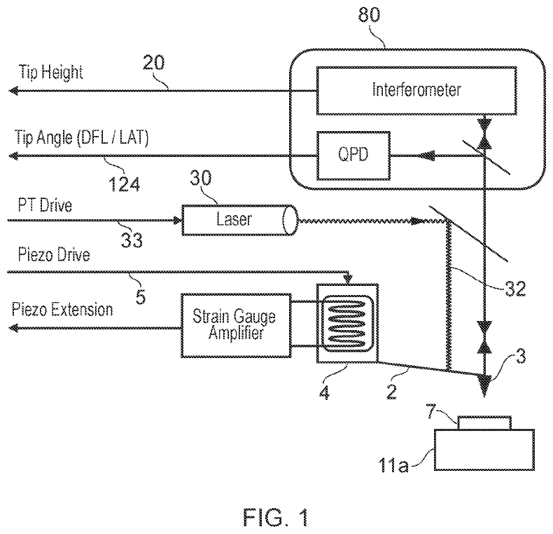

A scanning probe microscopy system according to an embodiment of the invention is shown in FIG. 1. The system comprises a piezoelectric driver 4 and a probe comprising a cantilever 2 and a probe tip 3. The bottom of the piezoelectric driver 4 provides a cantilever mount, with the cantilever 2 extending from the cantilever mount from a proximal end or base to a distal free end. The probe tip 3 is carried by the free end of the cantilever 2.

The probe tip 3 comprises a conical or pyramidal structure that tapers from its base to a point at its distal end that is its closest point of interaction with a sample 7 on a sample stage 11a. The sample comprises a sample surface which defines a sample surface axis which is normal to the sample surface and in FIG. 1 also extends vertically. The cantilever 2 comprises a single beam with a rectangular profile extending from the cantilever mount 13. The cantilever 2 has a length of about 20 micron, a width of about 10 micron, and a thickness of about 200 nm.

In this example the probe tip 3 tapers to a point, but in other embodiments the probe tip 3 may be specially adapted for measuring sidewalls. For instance the probe tip 3 may have a flared shape.

The cantilever 2 is a thermal bimorph structure composed of two (or more) materials, with differing thermal expansions-typically a silicon or silicon nitride base with a gold or aluminium coating. The coating extends the length of the cantilever and covers the reverse side from the tip 3. An illumination system (in the form of a laser 30) under the control of photothermal (PT) drive 33 is arranged to illuminate the cantilever on its upper coated side with an intensity-modulated radiation spot.

The cantilever 2 is formed from a monolithic structure with uniform thickness. For example the monolithic structure may be formed by selectively etching a thin film of SiO₂ or SiN₄ as described in Albrecht T., Akamine, S., Carver, T. E., Quate, C. F. J., Microfabrication of cantilever styli for the atomic force microscope, Vac. Sci. Technol. A 1990, 8, 3386 (hereinafter referred to as “Albrecht et al.”). The tip 3 may be formed integrally with the cantilever, as described in Albrecht et al., it may be formed by an additive process such as electron beam deposition, or it may be formed separately and attached by adhesive or some other attachment method.

The wavelength of the actuation beam 32 output by the laser 30 is selected for good absorption by the coating, so that the cantilever 2 bends along its length and moves the probe tip 3. In this example the coating is on the reverse side from the sample so the cantilever 2 bends down towards the sample when heated, but alternatively the coating may be on the same side as the sample so the cantilever 2 bends away from the sample when heated.

The piezoelectric driver 4 expands and contracts up and down in the Z-direction in accordance with a piezo drive signal 5 at a piezo driver input. As described further below, the piezo drive signal 5 causes the piezoelectric driver 4 to move the probe repeatedly towards and away from the sample 7 in a series of cycles. The piezo drive signal 5 is generated by a piezo controller (not shown). Typically the piezoelectric driver 4 is mechanically guided by flexures (not shown).

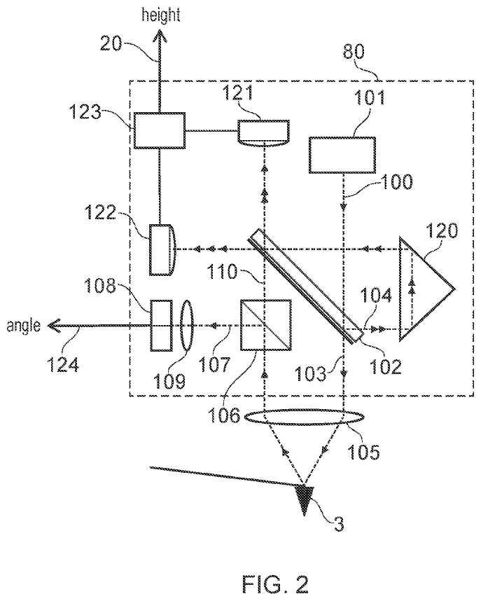

A measurement system 80 is arranged to detect a height and angle of the free end of the cantilever 2 directly opposite to the probe tip 3. The measurement system 80 includes an interferometer which measures height, and a quadrant photodiode (QPD) which measures angle. FIG. 1 only shows the measurement system 80 schematically and FIG. 2 gives a more detailed view. Light 100 from a laser 101 is split by a beam splitter 102 into a sensing beam 103 and a reference beam 104. The reference beam 104 is directed onto a suitably positioned retro-reflector 120 and thereafter back to the beam splitter 102. The retro-reflector 120 is aligned such that it provides a fixed optical path length relative to the vertical (Z) position of the sample 7. The beam splitter 102 has an energy absorbing coating and splits both the incident 103 and reference 104 beams to produce first and second interferograms with a relative phase shift of 90 degrees. The two interferograms are detected respectively at first 121 and second 122 photodetectors.

Ideally, the outputs from the photodetectors 121, 122 are complementary sine and cosine signals with a phase difference of 90 degrees. Further, they should have no dc offset, have equal amplitudes and only depend on the position of the cantilever and wavelength of the laser 101. Known methods are used to monitor the outputs of the photodetectors 121, 122 while changing the optical path difference in order to determine and to apply corrections for errors arising as a result of the two photodetector outputs not being perfectly harmonic, with equal amplitude and in phase quadrature. Similarly, dc offset levels are also corrected in accordance with methods known in the art.

These photodetector outputs are suitable for use with a conventional interferometer reversible fringe counting apparatus and fringe subdividing apparatus 123, which may be provided as dedicated hardware, FPGA, DSP or as a programmed computer. Phase quadrature fringe counting apparatus is capable of measuring displacements in the position of the cantilever to an accuracy of λ/8. That is, to 66 nm for 532 nm light.

Known fringe subdividing techniques, based on the arc tangent of the signals, permit an improvement in accuracy to the nanometre scale or less. In the embodiment described above, the reference beam 104 is arranged to have a fixed optical path length relative to the Z position of the sample 7. It could accordingly be reflected from the surface of the stage 11a on which the sample 7 is mounted or from a retro-reflector whose position is linked to that of the stage. The reference path length may be greater than or smaller than the length of the path followed by the beam 103 reflected from the probe. Alternatively, the relationship between reflector and sample Z position does not have to be fixed. In such an embodiment the reference beam may be reflected from a fixed point, the fixed point having a known (but varying) relationship with the Z position of the sample. The height of the tip is therefore deduced from the interferometically measured path difference and the Z position of the sample with respect to the fixed point.

The interferometer detector is one example of a homodyne system. The particular system described offers a number of advantages to this application. The use of two phase quadrature interferograms enables the measurement of cantilever displacement over multiple fringes, and hence over a large displacement range. Examples of an interferometer based on these principles are described in U.S. Pat. No. 6,678,056 and WO2010/067129. Alternative interferometer systems capable of measuring a change in optical path length may also be employed. A suitable homodyne polarisation interferometer is described in EP 1 892 727 and a suitable heterodyne interferometer is described in U.S. Pat. No. 5,144,150.

Returning to FIG. 1, the output of the interferomer is a height signal on a height detection line 20 which is input to a surface height calculator (not shown) and a surface detection unit (not shown). The surface detection unit is arranged to generate a surface signal on a surface detector output line for each cycle when it detects an interaction of the probe tip 3 with the sample 7.

The reflected beam is also split by a beam splitter 106 into first and second components 107, 110. The first component 107 is directed to a segmented quadrant photodiode 108 via a lens 109, and the second component 110 is split by the beam splitter 102 and directed to the photodiodes 121, 122 for generation of the height signal on the output line 20. The photodiode 108 generates angle data 124 which is indicative of the position of the first component 107 of the reflected beam on the photodiode 108, and varies in accordance with the angle of inclination of the cantilever relative to the sensing beam 103.

The angle data 124 comprises a deflection/bending signal which indicates a flexural angle of the cantilever—i.e an angle which changes as the cantilever bends along its length. Thus the deflection/bending signal is indicative of the flexural shape of the cantilever. The deflection/bending signal may be determined in accordance with a difference between the signals from the top and bottom halves of the quadrant photodiode 108.

The angle data 124 also comprises a lateral/twisting signal which indicates a torsion angle of the cantilever—i.e an angle which changes as the cantilever twists. Thus the lateral/twisting signal is indicative of the torsional shape of the cantilever. The lateral/twisting signal may be determined in accordance with a difference between the signals from the left and right halves of the quadrant photodiode 108.

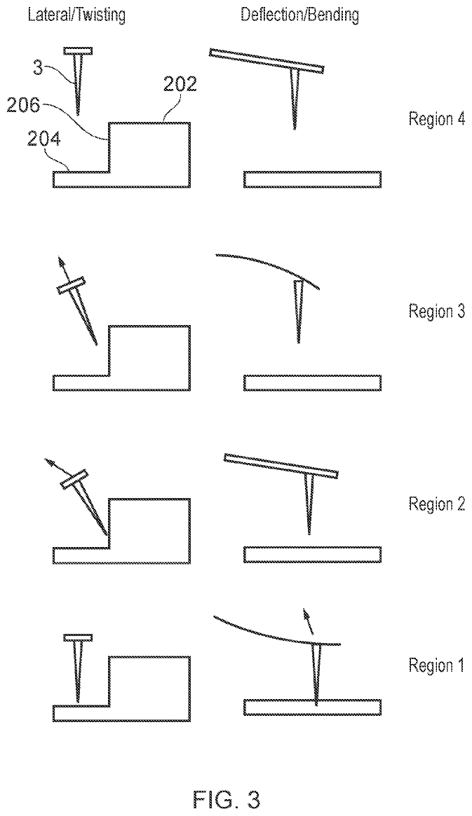

FIG. 3 shows the steps of a measurement of a sidewall of the sample 7. The sample 7 comprises an upper surface 202, a lower surface 204 and a sidewall 206 between the upper surface 202 and the lower surface 204. The upper surface 202 meets the apex of the sidewall 206 at a convex corner and the lower surface 204 meets the base of the sidewall 206 at a concave corner. The sidewall 206 may form part of a structure in the sample such as a well or a protrusion.

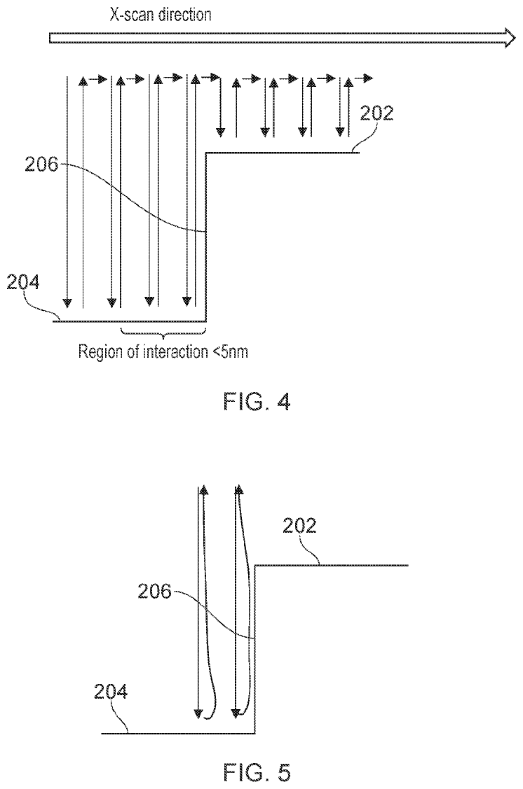

During scanning of the upper and lower surfaces, the probe is made to approach and retract from the sample 7 in a series of measurement cycles shown in FIG. 4, each approach and retract drive phase making up one cycle which involves taking a single measurement point when the probe contacts the sample surface.

The probe is scanned laterally across the sample by an XY driver which drives the probe in a raster scanning pattern. FIG. 4 indicates the X-scan direction of the raster scanning pattern. In this example the motion of the cantilever mount is indicated by the arrows in FIG. 4. In each measurement cycle the cantilever mount moves vertically down then vertically up. The horizontal motion is driven by the XY driver. The XY driver may continuously move the probe in the X-scan direction, or it may move the probe in a “stop-start” motion with no motion in the X-scan direction as the probe approaches and retracts.

A dither signal may be applied to the probe during the first (approach) drive phase as a means of determining contact with the lower surface 204. The dither signal is applied using a signal from the photothermal drive 33 to illuminate the back of the cantilever 2 with an actuation beam 32. Using this actuation beam 32 it is possible to cause the probe to oscillate with a dither oscillation. For each measurement cycle, the dither oscillation, as measured by the interferometer or the quadrant photodiode, is monitored to detect contact of the probe with the sample. For example the phase or amplitude of the dither oscillation may change and this change may be detected to detect the contact.

In an alternative embodiment, the deflection/bending signal may be monitored to detect contact of the probe with the sample. For example the deflection/bending signal may change abruptly as the probe contacts the sample, and this change may be detected to detect the contact. In this case, no dither signal is required so the photothermal actuation system 33, 30 may be omitted and the cantilever 2 does not need to have a thermal bimorph structure.

FIG. 4 illustrates a series of four upper surface measurements of the upper surface 202. Each upper surface measurement is taken during an upper surface measurement cycle, the upper surface measurement cycle comprising an approach drive phase in which the cantilever mount is driven down so that the probe is driven down to the upper surface 202 followed by a retract drive phase in which the cantilever mount is driven up so that the probe is driven up and away from the upper surface 202. A single measurement is taken for each upper surface measurement cycle, by taking a height reading from the interferometer detector when contact with the upper surface 202 is detected by monitoring the dither oscillation. The approach drive phase may be terminated in response to the detection of the contact of the probe with the sample. Optionally the dither signal is not applied to the probe during the retract drive phase.

FIG. 4 also illustrates a series of two lower surface measurements of the lower surface 204. Each lower surface measurement is taken during a lower surface measurement cycle, the lower surface measurement cycle comprising an approach drive phase in which the cantilever mount is driven down so that the probe is driven down to the lower surface 204 followed by a retract drive phase in which the cantilever mount is driven up so that the probe is driven up and away from the lower surface 204. A single measurement is taken for each lower surface measurement cycle, by taking a height reading from the interferometer detector when contact with the lower surface 204 is detected by monitoring the dither oscillation. The approach drive phase may be terminated in response to the detection of the contact of the probe with the sample. Optionally the dither signal is not applied to the probe during the retract drive phase.

When in proximity to the sidewall 206, within a region of interaction of the order of 5 nm indicated in FIG. 4, the probe undergoes a pair of sidewall measurement cycles. Each sidewall measurement cycle comprises a pair of sidewall measurement drive phases. The pair of sidewall measurement drive phases comprises a first drive phase in which the cantilever mount is driven down so that the probe is driven down (i.e. towards the base of the sidewall), followed by a second drive phase in which the cantilever mount is driven up so that the probe is driven up (i.e. away from the base of the sidewall).

During each drive phase of a sidewall measurement cycle, the probe is next to the sidewall 206. In this context, “next to” means adjacent to, and possibly but not necessarily interacting with the sidewall 206. The probe is sufficiently close to the sidewall, that during at least one of the drive phases it lies within a region of interaction. The region of interaction will depend on the nature of the sample and the probe, for instance whether the sample and/or the probe is charged. By way of non-limiting example, during each sidewall measurement cycle the probe tip may be within 100 nm of the sidewall, within 50 nm of the sidewall, within 10 nm of the sidewall, or within 5 nm of the sidewall.

During the sidewall measurement cycle the sidewall 206 applies a force to the probe tip 3 which causes the cantilever to twist, such that during one or both of the sidewall measurement drive phases the probe tip 3 interacts with the sidewall 206.

In the example of FIG. 4 the force is an attractive force resulting from the Van der Waals interaction, and the probe tip 3 interacts with the sidewall 206 during the second drive phase in which the probe is driven up next to the sidewall 206.

A series of sidewall measurements are taken by measuring an angle of the cantilever as the probe tip interacts with the sidewall during the second sidewall measurement drive phase.

FIG. 5 schematically illustrates motion of the probe tip during the pair of sidewall measurement cycles. In the first drive phase the probe tip moves down vertically next to the sidewall, then “snaps” into contact with the sidewall. In the second drive phase the probe tip is dragged up the sidewall. The Van der Waals interaction reduces as the probe is retracted, so the cantilever untwists and the probe tip moves away from the sidewall as it moves up.

If a dither signal is applied to the probe during the first drive phase of each sidewall measurement cycle to cause a dither oscillation of the probe, then the dither oscillation may be monitored to detect contact of the probe with the sample. The first drive phase may be terminated in response to the detection of the contact of the probe with the sample. Optionally the dither signal is applied to the probe during the first drive phase and not applied to the probe during the second drive phase. This lack of dither signal in the second drive phase makes it more easy to accurately measure the angle of the cantilever as it interacts with the sidewall.

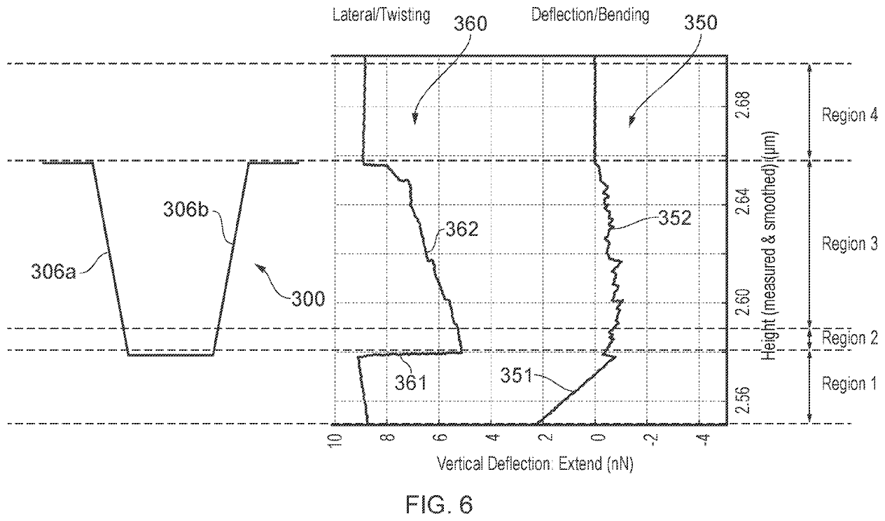

In the example of FIG. 5, at the end of each first drive phase the probe contacts the lower surface 204 and the detection of this contact triggers the reversal of the driver 4 and the retraction of the probe in the second drive phase. In other embodiments, for instance with an angled sidewall 306b as shown in FIG. 6, the probe may contact the sidewall 306b without contacting the lower surface.

Starting from the base of the sidewall 206, four regions making up the second drive phase are shown in FIG. 3. For each region, the lateral/twisting motion of the probe is shown on the left-hand side of FIG. 3, with the cantilever extending into or out of the page in these figures. The deflection/bending motion of the probe is also shown for each region on the right-hand side of FIG. 3, with the sidewall behind or in front of the probe in or out of the page.

Starting at region 1, the probe is in contact with the lower surface 204, and is pushing into this surface slightly. There is therefore no or negligible twisting of the probe, but there is some positive deflection, due to the probe tip 3 being pushed into the lower surface 204.

Region 2 shows the lateral/twisting and deflection/bending motion when the probe is retracted slightly. No longer pushed into the lower surface 204, the probe unbends and is attracted towards the sidewall 206 by the Van der Waals force. There is therefore some twisting experienced. However, the probe has unbent so there is no deflection/bending.

Region 3 shows the lateral/twisting and deflection/bending motion when the probe is retracted further up the sidewall 206. The probe continues to be attracted to the sidewall 206 by the Van der Waals force. As the piezoelectric driver moves the probe up, the probe is dragged up the sidewall 206. It moves in a sliding motion, temporarily sticking on the sidewall due to attractive forces from features of the sidewall, then unsticking as force from the driver 4 moving the probe upwards overcomes the attractive force. The probe remains in a twisted state, and slides up the sidewall, sometimes in contact with and sometimes not in contact with the sidewall as it becomes stuck and unstuck. The cantilever 2 is deflected negatively when the probe tip 3 sticks to the sidewall 206.

Region 4 shows the probe when it has been fully retracted, to the point where there is no or negligible attractive force between the probe and the sidewall 206. There is no twisting and no deflection of the probe.

By obtaining a series of measurements of the lateral/twisting signal and the deflection/bending signal as the probe is retracted, it is possible to determine a characteristic of the sidewall 206. This may be a geometric characteristic, such as a profile or shape of the sidewall 206, or a material characteristic for example.

Each series of sidewall measurements comprises a “sidewall signature”, which can be analysed to determine the characteristic of the sidewall. Analysing the sidewall measurements may comprise calculating the work done in retracting the probe during the sidewall measurement cycle. The work done may be calculated by determining an area under the curve of the deflection/bending signal (which is indicative of the work done); and/or by determining an area under the curve of the lateral/twisting signal (which is also indicative of the work done).

One or more regions (regions 1 and 4, for example) may be omitted from the sidewall measurement cycle if only part of the sidewall 206 is measured. The method may involve performing two or more sidewall measurement cycles at different distances from the sidewall, and determining the characteristic of the sidewall 206 by selecting and analysing one of the sidewall measurement cycles, such as the one considered to provide the “best” /most useful dataset. So in the example of FIG. 5, only the second measurement cycle (i.e. the cycle closest to the sidewall) may be used. Alternatively, an average of the sidewall measurement cycles may be used, such as a mean value for each of the measurement points within the cycles.

In FIGS. 4 and 5, the series of sidewall measurements for each measurement cycle are taken by measuring an angle of the cantilever as the probe interacts with the sidewall during the second drive phase—i.e. by taking a series of samples of the lateral/twisting signal and the deflection/bending signal as the probe tip slides up the sidewall. A probe height measurement is also taken at the same time as each sidewall measurement. As explained below, the probe height measurements may be taken from the piezo drive signal 5, or from the interferometer.

In an equivalent method, the series of sidewall measurements for each measurement cycle may be taken by measuring an angle of the cantilever as the probe interacts with the sidewall during the first drive phase—i.e. as the probe tip slides down the sidewall. In the first drive phase the probe tip slides down the sidewall (i.e. towards the base of the sidewall) and the series of sidewall measurements are taken. In the second drive phase the probe tip moves up next to the sidewall, i.e. away from the base of the sidewall.

FIG. 6 shows a typical well 300 in a sample surface, the well having a pair of sidewalls 306a, 306b. The sidewalls 306a, 306b in this example are substantially straight.

Trace 350 indicates the deflection/bending signal, which is plotted along with the height of the cantilever. Trace 360 indicates the lateral/twisting signal, which is plotted along with the height of the cantilever.

Note that the scale in FIG. 6 labelled as “Vertical Deflection Extend (nN)” is associated with the deflection/bending signal, and not with the lateral/twisting signal. This scale is based on the deflection/bending signal multiplied by the flexural spring constant of the cantilever—giving a force in nN.

The other scale in FIG. 6 (labelled as “Height (measured and smoothed) μm)”) is based on the piezo drive signal 5 (which controls the piezoelectric driver 4 which drives the base of the cantilever 2). Thus this scale effectively indicates the height of the proximal end or base of the cantilever, rather than the height of the distal end which carries the probe tip.

The cantilever changes shape as the probe tip slides up the sidewall, and the series of sidewall measurements vary in accordance with the changing shape of the cantilever, as indicated by the traces 350 and 360.

The series of sidewall measurements, represented by traces 350 and 360, will typically comprise 100s or 1000s of sidewall measurements, each sidewall measurement comprising a single sample from the quadrant photodiode.

When the probe is in Region 1, the probe height is at a minimum (about 2.55 μm) and the cantilever is bent up, as indicated in FIG. 3. So the deflection/bending signal, indicated by trace 350, is also at a maximum (about 2 nN). As the piezoelectric driver 4 retracts, the cantilever unbends (as indicated by section 351 of the trace 350) until the probe tip lifts off from the lower surface.

Note that in this example a series of probe height measurements are taken which are indicative of a height of the base of the cantilever at the cantilever mount. In other words, the height component of each trace 350, 360 is based on the piezo drive signal 5 and thus effectively indicates the height of the proximal end or base of the cantilever at the cantilever mount, rather than the height of the distal end which carries the probe tip. This can be seen from the fact that in Region 1 the height component of the trace 350 is changing, even though the probe tip remans in contact with the lower surface.

In an alternative embodiment, the series of probe height measurements may be indicative of a height of the free end of the cantilever. In a first example such probe height measurements may be made by subtracting the deflection/bending signal from the piezo drive signal 5. In a second example such probe height measurements may be based instead on the height signal 20 from the interferometer. So in the second example the height component of each trace 350, 360 will be based instead on the height signal 20 from the interferometer, which effectively indicates the vertical position of the distal or free end of the cantilever which carries the probe tip. In either the first or second examples, in Region 1 the height component of the trace 350 would not change.

As the probe tip lifts off, at the end of Region 1, the Van der Waals force or other attractive forces causes the probe tip to snap into contact with the sidewall, and the lateral/twisting signal goes sharply negative (as indicated by section 361 of the trace 360).

In Region 3 the cantilever gradually untwists (as indicated by section 362 of the trace 360) and the cantilever is slightly bent down (as indicated by section 352 of the trace 350).

Both of these signals contain information about the sidewall, so the series of sidewall measurements in Region 3 can be analysed to determine a characteristic of the sidewall.

In one example it may be possible to infer the angle of the sidewall from the angle of the section 362 of the trace 360. Thus the series of measurements of the lateral/twisting signal in Region 3 can be analysed to determine the angle of the sidewall.

The area under the trace 350 and the area under the trace 360 each represent a force (in nN) multiplied by a distance (in μm), and thus are indicative of a work done, or energy. In another example, by calculating the area under the trace 350 and/or the area under the trace 360, the work done can be calculated and used to infer a property of the sidewall. In this example the area under the trace 350 (deflection/bending) is relatively small and this can be used to infer the fact that the sidewall is relatively straight.

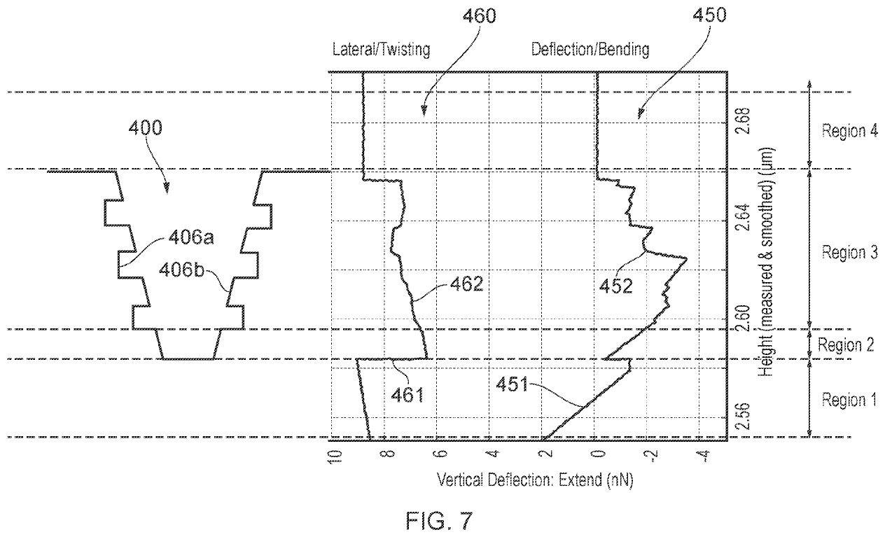

FIG. 7 shows an alternative well 400, again having a pair of sidewalls 406a, 406b. These sidewalls 406a, 406b are more structured and so the data obtained from the aforementioned method of the four regions is therefore different to that obtained with the well 300 of FIG. 6.

Trace 450 indicates the deflection/bending signal, which is plotted along with the height of the cantilever. When the probe is in Region 1, the height is at a minimum (about 2.55 μm) and the cantilever is bent up, as indicated in FIG. 3, so the deflection/bending signal is also at a maximum (about 2 nN). As the piezoelectric driver 4 retracts, the cantilever unbends (as indicated by section 451 of the trace 450) until the probe tip lifts off from the lower surface.

Trace 460 indicates the lateral/twisting signal, which is plotted along with the height of the cantilever. As the probe tip lifts off, in Region 1, the probe tip snaps into contact with the sidewall, and the lateral/twisting signal goes sharply negative (as indicated by section 461 of the trace 460). Note that the scale in FIG. 7 labelled as “Vertical Deflection Extend (nN)” is associated with the deflection/bending signal, and not with the lateral/twisting signal.

In Region 3 the cantilever gradually untwists (as indicated by section 462 of the trace 460) in a similar fashion to trace 350. However, the section 452 of the trace 450 in Region 3 is very different to the equivalent section of the trace 350, due to the more complex shape of the sidewall 406b which causes the probe tip to stick and unstick from the sidewall 406b in a complex way.

Both of these traces 450, 460 contain information about the sidewall 406b, so the sidewall measurements associated with one or both traces 450, 460 can be analysed to determine a characteristic of the sidewall.

In one example it may be possible to infer the angle of the sidewall from the angle of the section 462 of the trace 460. Thus the series of measurements of the lateral/twisting signal in Region 3, and their associated probe height measurements, can be analysed to determine the angle of the sidewall.

The area under the trace 450 and the area under the trace 460 each represent a force (in nN) multiplied by a distance (in μm), and thus are indicative of a work done, or energy. In another example, by calculating the area under the trace 450 and/or the area under the trace 460, the work done can be calculated and used to infer a property of the sidewall. In this example the area under trace 450 (deflection/bending) is much larger than for trace 350, and this can be used to infer the fact that the sidewall has a more undulating or complex profile.

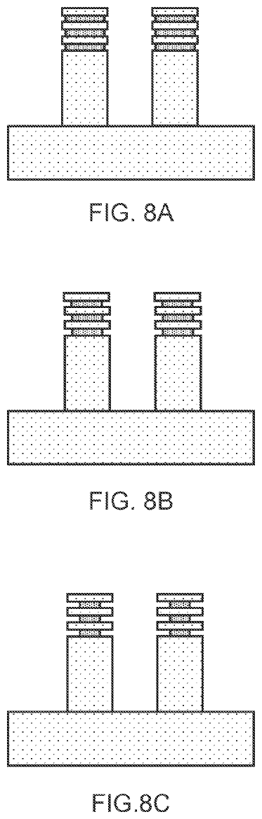

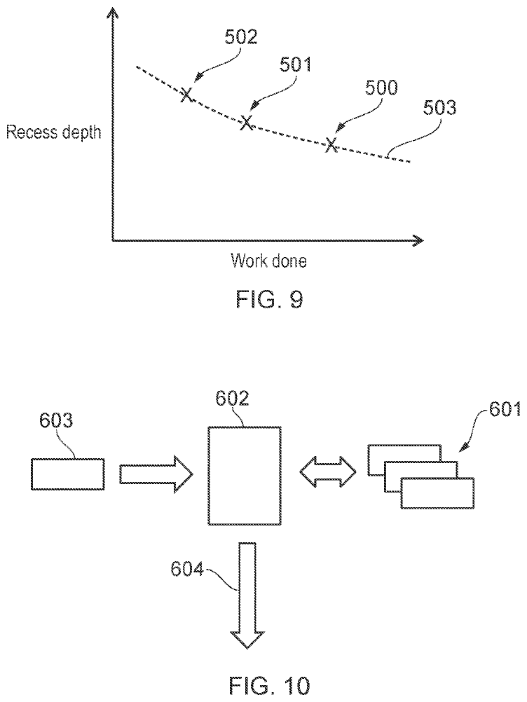

FIGS. 8A-C and FIG. 9 illustrate a model-based method which calculates a work done in order to determine a “recess depth” characteristic of a sidewall.

In an initial calibration phase, a plurality of calibration samples shown in FIGS. 8A-C are provided. Each calibration sample has calibrations sidewalls with a different recess depth. In this case the calibration sidewalls of FIG. 8A have the lowest recess depth and the calibration sidewalls of FIG. 8C have the highest recess depth.

The depths of the recesses may be known based on the process of manufacturing the calibration samples, or they may be measured by transmission electron micrography.

For each calibration sidewall, a calibration sidewall signature is obtained by measuring an interaction of a probe with the calibration sidewall, using the process described above or any other suitable probing method. Each calibration sidewall signature comprises a series of measurements which are taken at different points as the probe moves up or down the calibration sidewall.

Each calibration sidewall signature is then analysed by calculating a work done. FIG. 9 plots three data points 500, 501, 502 associated with the calibration samples of FIGS. 8A, 8B and 8C respectively. Data point 500 indicates the work done for the calibration sample of FIG. 8A with the smallest recess depth, and so on.

Next, a model is generated by correlating the calibration sidewall signatures with the known characteristics of the calibration sidewalls. In this case the model is a numerical model identified by a line 503 connecting the data points 500-502.

Once the model 503 of FIG. 9 has been generated, it can then be used to determine an unknown recess depth of a test sidewall. That is, the recess depth can be determined by obtaining a test sidewall signature by measuring an interaction of a probe with the test sidewall (using the process described above or any other suitable probing method) and inputting the test sidewall signature into the model 503 of FIG. 9. For a given work done, the model 503 of FIG. 9 outputs a recess depth. The model 503 may be implemented as a look-up-table, for example.

An alternative model-based method of determining a characteristic of a test sidewall is illustrated in FIG. 10. A test sidewall signature 603 of the test sidewall is obtained by measuring an interaction of a probe with the test sidewall. The test sidewall signature comprises a series of measurements which are taken at different points as the probe moves up or down the test sidewall, using the process described above or any other suitable probing method.

The test sidewall signature 603 is input into a mathematical model 602. The mathematical model 602 is generated by providing a plurality of calibration sidewalls, each having a different known characteristic, for instance the three calibration sidewalls of FIGS. 8A-C. For each calibration sidewall, a calibration sidewall signature is obtained by measuring an interaction of a probe with the calibration sidewall, using the process described above or any other suitable probing method. Each calibration sidewall signature comprises a series of measurements which are taken at different points as the probe moves up or down the calibration sidewall. The mathematical model 602 is generated by correlating the calibration sidewall signatures 601 with the known characteristics of the calibration sidewalls.

The mathematical model 602 effectively compares the sidewall signature 603 with the calibration sidewall signatures 601 and determines which is most similar. The recess depth of the most similar calibration sidewall signature 601 is then output at 604 as an estimate of the recess depth of the test sidewall.

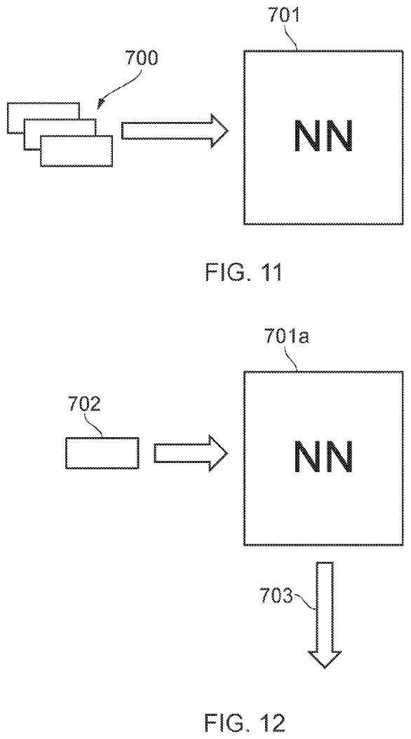

An alternative machine-based method is shown in FIGS. 11 and 12. FIG. 11 shows a method of training a model 701, which in this case is a neural network although any other type of model capable of machine learning may be used. A plurality of calibration sidewalls are provided, each having a different known characteristic. For instance the three sidewalls of FIGS. 8A-C may be provided, each with a known recess depth.

For each calibration sidewall, a calibration sidewall signature is obtained by measuring an interaction of a probe with the calibration sidewall. Each calibration sidewall signature comprises a series of measurements which are taken at different points as the probe moves up or down the calibration sidewall, using the process described above or any other suitable probing method. A set of calibration sidewall signatures is indicated at 700 in FIG. 11.

The model 701 is then trained on the basis of the calibration sidewall signatures 700 and the known characteristics of the calibration sidewalls (in this case, the recess depths). The training of the model 701 modifies the weights between nodes of the neural network. The training process of FIG. 11 transforms the un-trained model 701 to a trained model 701a shown in FIG. 12.

Once the trained model 701a has been generated by a suitable machine learning process, it can be used to determine an unknown recess depth of a test sidewall by the method shown in FIG. 12. That is, the recess depth is determined by obtaining a test sidewall signature 702 (by measuring an interaction of a probe with the test sidewall using the process described above or any other suitable probing method) and inputting the test sidewall signature 702 into the trained model 701a which outputs a recess depth 703. In this case, the trained model 701a in FIG. 12 is a trained neural network, but in other embodiments the trained model 701a may be any other type of trained model, for example a trained machine which has been trained by supervised machine learning or unsupervised machine learning.

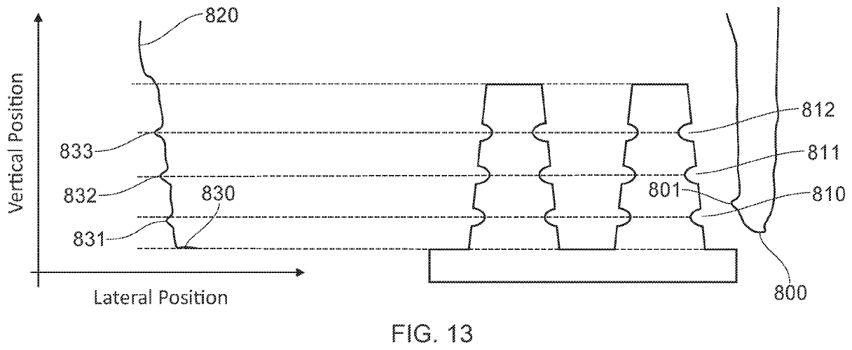

FIG. 13 shows a method of measuring a sample with a probe, according to a further embodiment of the invention.

The probe comprises a cantilever mount (not shown) such as the bottom of the piezoelectric driver 4 of FIG. 1; and a cantilever (not shown) extending from the cantilever mount to a free end. The cantilever may be similar to the cantilever 2 of FIG. 1.

A probe tip is carried by the free end of the cantilever, and FIG. 13 shows the distal end of the probe tip including its apex 800. In this example the probe tip has an asperity (a small protrusion) 801 extending laterally from the probe tip, near the apex 800 of the probe tip.

A sample shown in FIG. 13 has sidewalls with notches 810-812. Each sidewall is measured by taking a series of measurements of the sidewall with the probe; and analysing the series of measurements to determine a characteristic of the sidewall, similar to the previous embodiments of the invention.

In this example, as the probe is driven up next to the sidewall by the piezoelectric driver 4, the probe tip interacts with the sidewall, and the series of measurements are taken.

At each point in time, a lateral position is obtained along with an associated vertical position. Together, these positions can be interpreted as representing the position of the apex 800 of the probe tip as the probe tip slides up the sidewall.

A time series of such positions is illustrated by the trace 820 in the left-hand side of FIG. 13, which can be considered as a sidewall signature representing a trajectory of the apex 800 of the probe tip.

The vertical position for each point of the trace 820 may be a height measurement obtained by measuring a height of the cantilever as the probe tip interacts with the sidewall. For instance the vertical position may be calculated from the extension of the piezoelectric driver 4 (which can be measured directly or inferred from the piezo drive signal 5); and the deflection/bending signal which indicates a flexural angle of the cantilever (and which can be measured by the vertical position of the first component 107 on the segmented quadrant photodiode 108, or by any other means). Alternatively, the vertical position for each point of the trace 820 may be measured directly by the height signal on the height detection line 20, which provides a direct interferometric measurement of the height of the free end of the cantilever.

The lateral position for each point of the trace 820 may be a sidewall measurement based on the lateral/twisting signal which indicates a torsion angle of the cantilever—i.e an angle which changes as the cantilever twists. Thus the lateral/twisting signal is indicative of the torsional shape of the cantilever. The lateral/twisting signal may be determined in accordance with a difference between the signals from the left and right halves of the quadrant photodiode 108.

At the start of the drive phase in which the probe is driven up next to the sidewall, the probe tip snaps laterally, bringing the asperity 801 into contact with the sidewall as indicated at 830. Then as the piezoelectric driver 4 contracts, the asperity 801 slides up the sidewall and into the first notch 810, resulting in a first feature 831 in the trace 820. This process continues as the probe tip is driven up next to the sidewall, providing further features 832, 833 associated with the notches 811, 812.

The sidewall signature (as represented by trace 820) may then be analysed to determine a characteristic of the sidewall: for instance the vertical spacing between the notches 810-812 and/or the depth of the notches 810-12 and/or the width of the notches 810-812.

The height measurements may be used along with the sidewall measurements (i.e. the lateral position measurements) to determine the characteristic of the sidewall. For example the height measurements may be used to estimate the vertical spacing between the notches 810-812 and/or the width of the notches 810-812.

FIG. 13 shows an example in which the probe tip has an asperity 801 which makes the features 831-833 in the trace more pronounced. In other embodiments the probe tip may have no asperity. In this case the features in the trace may be less pronounced, but still sufficiently distinguishable to enable a characteristic of the sidewall to be determined.

In the preceding examples, the words “up”, “down”, “top”, “bottom”, “upper”, “lower” are used in the context of a system which is oriented conventionally as shown in the Figures—i.e. with the sample under the probe so the probe is moving “down” during the first drive phase and “up” during the second drive phase, and with the sample oriented horizontally so that the upper surface is higher than the lower surface. However it will be understood that the system could optionally be oriented in a different way-for instance with the probe below the sample, or with the sample oriented vertically. In that case the words “up”, “down”, “upper”, “lower” etc. should be construed appropriately—for instance in the second drive phase the probe is driven “up” next to the sidewall in the sense that it moves away from the base of the sidewall.

In the preceding embodiments of the invention, the upper surface meets the top (or apex) of the sidewall at a convex corner and the lower surface meets the base of the sidewall at a concave corner. In the example of FIG. 4, the convex corner is directly above the concave corner so that the sidewall 206 is vertical. In other words, the average sidewall angle of the sidewall 206 is 90 degrees. In the example of FIG. 6, the convex corner is not directly above the concave corner so that the sidewall 306b is not vertical. In this case, the average sidewall angle of the sidewall 306b is about 80 degrees. The sidewall 306a has the same average sidewall angle of about 80 degrees. In the example of FIG. 7, each sidewall has an average sidewall angle of about 75 degrees (note the average sidewall angle is defined here as the angle of the sidewall from the horizontal, averaged from the top to the bottom of the sidewall).

In general terms, the method may be used to probe any sidewall with an average sidewall angle above 45 degrees, above 60 degrees or above 70 degrees. The sidewall may also be a re-entrant sidewall with an average sidewall angle above 90 degrees.

In the embodiments of FIGS. 6 and 7, the sidewall is a sidewall of an indented feature such as a trench or well. Alternatively, the sidewall may be a sidewall of a protruding feature, or a single step in an otherwise generally planar sample surface.

Although the invention has been described above with reference to one or more preferred embodiments, it will be appreciated that various changes or modifications may be made without departing from the scope of the invention as defined in the appended claims.

1. A method of measuring a sample with a probe, the probe comprising a cantilever mount, a cantilever extending from the cantilever mount to a free end, and a probe tip carried by the free end of the cantilever, the method comprising: taking a series of sidewall measurements of a sidewall of the sample with the probe; and analysing the series of sidewall measurements to determine a characteristic of the sidewall, wherein: the sidewall measurements are taken during a sidewall measurement cycle, the sidewall measurement cycle comprises a pair of sidewall measurement drive phases, the pair of sidewall measurement drive phases comprises a first drive phase in which the probe is driven down next to the sidewall followed by a second drive phase in which the probe is driven up next to the sidewall, during one of the sidewall measurement drive phases the probe tip interacts with the sidewall, and the series of sidewall measurements are taken by measuring an angle of the cantilever as the probe tip interacts with the sidewall during the one of the sidewall measurement drive phases.

2. The method of claim 1, wherein the series of sidewall measurements are taken by measuring an angle of the cantilever as the probe interacts with the sidewall during the second drive phase.

3. The method of claim 2, wherein the probe does not interact with the sidewall during the first drive phase.

4-6. (canceled)

7. The method of claim 1, wherein the probe tip interacting with the sidewall comprises a sliding interaction.

8. (canceled)

9. (canceled)

10. The method of claim 1, wherein analysing the series of sidewall measurements to determine a characteristic of the sidewall comprises calculating a work done.

11. The method of claim 1, wherein the series of sidewall measurements comprises at least one of flexural measurements of the cantilever, and torsional measurements of the cantilever.

12. The method of claim 1, further comprising taking a series of height measurements by measuring a height of the cantilever as the probe tip interacts with the sidewall during the one of the sidewall measurement drive phases.

13. The method of claim 1, further comprising applying a dither signal to the probe during the first drive phase to cause a dither oscillation of the probe, and monitoring the dither oscillation to detect contact of the probe with the sample.

14. The method of claim 13, wherein the dither signal is not applied to the probe during the second drive phase.

15. The method of claim 1, comprising performing two or more sidewall measurement cycles, and using the two or more sidewall measurement cycles to determine the characteristic of the sidewall.

16. The method of claim 1, wherein the sample comprises an upper surface which meets the sidewall at a convex corner, and a lower surface which meets the sidewall at a concave corner.

17. The method of claim 16, further comprising: taking a series of upper surface measurements of the upper surface with the probe, wherein each upper surface measurement is taken during an upper surface measurement cycle, the upper surface measurement cycle comprising an approach drive phase in which the probe is driven down to the upper surface followed by a retract drive phase in which the probe is driven up and away from the upper surface; and taking a series of lower surface measurements of the lower surface with the probe, wherein each lower surface measurement is taken during a lower surface measurement cycle, the lower surface measurement cycle comprising an approach drive phase in which the probe is driven down to the lower surface followed by a retract drive phase in which the probe is driven up and away from the lower surface.

18. (canceled)

19. The method of claim 1, wherein analysing the series of sidewall measurements to determine the characteristic of the sidewall comprises: inputting the series of sidewall measurements into a model, wherein the model determines the characteristic of the sidewall on the basis of the series of sidewall measurements.

20. Apparatus for measuring a sample with a probe, the apparatus comprising: a cantilever mount; a probe comprising a cantilever extending from the cantilever mount to a free end, and a probe tip carried by the free end of the cantilever; a driver configured to drive the probe; and a measurement system configured to measure an angle of the cantilever to generate a series of sidewall measurements; wherein the apparatus is configured to: take a series of sidewall measurements of a sidewall of the sample with the probe; and analyse the series of sidewall measurements to determine a characteristic of the sidewall, wherein: the sidewall measurements are taken during a sidewall measurement cycle, the sidewall measurement cycle comprises a pair of sidewall measurement drive phases, the pair of sidewall measurement drive phases comprise a first drive phase in which the probe is driven down next to the sidewall followed by a second drive phase in which the probe is driven up next to the sidewall, during one of the sidewall measurement drive phases the probe tip interacts with the sidewall, and the series of sidewall measurements are taken by measuring an angle of the cantilever as the probe tip interacts with the sidewall during the one of the sidewall measurement drive phases.

21. The apparatus of claim 20, wherein the series of sidewall measurements comprises at least one of flexural measurements of the cantilever, and torsional measurements of the cantilever.

22. (canceled)

23. The apparatus of claim 20, further comprising a model configured to determine the characteristic of the sidewall on the basis of the series of sidewall measurements.

24. A method of measuring a test sidewall, the method comprising: obtaining a sidewall signature by measuring an interaction of a probe with a test sidewall, wherein the sidewall signature comprises a series of measurements which are taken at different points as the probe moves up or down the test sidewall; and inputting the sidewall signature into a model, wherein the model determines a characteristic of the test sidewall on the basis of the sidewall signature.

25. (canceled)

26. A method of generating a model, the method comprising: providing a plurality of calibration sidewalls, each having a different known characteristic; for each calibration sidewall, obtaining a calibration sidewall signature by measuring an interaction of a probe with the calibration sidewall, wherein the calibration sidewall signature comprises a series of measurements which are taken at different points as the probe moves up or down the calibration sidewall; and generating the model on the basis of the calibration sidewall signatures and the known characteristics of the calibration sidewalls.

27. (canceled)

28. (canceled)

29. Apparatus for measuring a sidewall, the apparatus comprising: a probe; a measurement system configured to obtain a sidewall signature by measuring an interaction of the probe with a sidewall, wherein the sidewall signature comprises a series of measurements which are taken at different points as the probe moves up or down the sidewall; and a model configured to determine a characteristic of the sidewall on the basis of the sidewall signature.

30. The apparatus of claim 29, wherein the measurement system is configured to obtain the sidewall signature during a sidewall measurement cycle, the sidewall measurement cycle comprising a pair of sidewall measurement drive phases, the pair of sidewall measurement drive phases comprising a first drive phase in which the probe is driven down next to the sidewall followed by a second drive phase in which the probe is driven up next to the sidewall, during one of the sidewall measurement drive phases a probe tip of the probe interacts with the sidewall, and the series of measurements are taken by measuring an angle of a cantilever of the probe as the probe tip interacts with the sidewall during the one of the sidewall measurement drive phases.
